(19) United States
(12) Patent Application Publication
(10) Pub. No.: US 2006/0088650 A1
(43) Pub. Date: Apr. 27, 2006

(54) Palatable vegetarian pet food

(75) Inventor: Scott McGrane, Wodonga (AU)

Correspondence Address: FULBRIGHT & JAWORSKI, LLP, 1301 MCKINNEY, SUITE 5100, HOUSTON, TX, 77010-3095, US

(73) Assignee: Mars, Inc., McLean, VA (US)

(21) Appl. No.: 10/519,260

(22) PCT Filed: Jun. 19, 2003
(86) PCT No.: PCT/AU03/00762

§ 371 Date: Jun. 29, 2005

(30) Foreign Application Priority Data
Jun. 21, 2002 (AU) PS 3116

(51) Int. Cl. A23J 1/00

(52) U.S. Cl. 426/656

(57) ABSTRACT

A palatable, nutritionally complete vegetarian food for pet mammals, including a nutritionally complete, preferably low moisture, vegetarian kibble which incorporates a non-meat based flavour-enhancing additive. The additive includes a synergistic amount of hydrolyzed vegetable protein and xylose. The combination of these two ingredients provides an especially flavoursome character to the pet food. Also disclosed are the additive and a method of enhancing the flavour of such foods using the additive.

### FIELD OF THE INVENTION

The invention relates to the field of commercial pet food manufacture. In particular it relates to a vegetarian pet food that is nutritionally complete and highly palatable.

### BACKGROUND OF THE INVENTION

For many years, commercial pet foods have been based on meat and meat-derived by-products. This is partly because these products are usually highly palatable to pet mammals, including dogs and cats. Typically, such products are marketed in a canned format.

A move toward more convenient delivery formats for commercial pet foods have seen a great increase in the popularity of dry, packeted pet foods in the form of cereal-based kibbles. Typically these foods are based on cereals such as rice, maize and wheat and are produced by a variety of well-known extrusion techniques.

A drawback for such products is that dogs and cats typically do not find cereal-based products to be as palatable as meat-based products. To counter this, a wide range of technologies has been developed to imbue these cereal-based products with suitably acceptable ‘meat flavours’. A common technique is to inject a highly palatable, meat-based material into the cereal mixture as it passes through the extruder. Another technique is to hydrolyze animal materials, such as chicken viscera, and to spray this material on to the extruded kibble. The liquid soaks into the kibble and provides an appealing flavour for the animal.

However, it may not always be appropriate to use such meat-based flavourings for packeted pet foods. For example, where such meat-based material are in short supply, or where the marketplace demonstrates a clear demand for genuinely meat-free or ‘vegetarian’ pet diets. Such demands may stem from perceived health benefits for the animal, or from cultural or religious traditions.

Therefore, workers in the field have sought to provide such vegetarian diets, which nevertheless are sufficiently palatable that the animal will readily consume them.

U.S. Pat. No. 5,141,755 by Weisman discloses a commercial, nutritionally complete pet food product that seeks to avoid the inclusion of meat-based products, particularly animal fats. This is achieved by replacing the meat-based fat content of a commercial packeted pet food with fats and proteins derived from dairy materials and/or eggs. However, this would not provide a pet food that is free from all animal-derived materials. In addition, such dairy- or egg-derived materials are usually relatively expensive and may not be commercially suitable or available.

U.S. Pat. No. 6,228,418, by Gluck et al discloses a commercial pet ‘treat’ product (as opposed to a nutritionally complete diet) that consists essentially of vegetarian ingredients, but which nevertheless may contain small amounts of meat-derived, palatability-enhancing ingredients, such as liver digest, meat digest or poultry digest. Again, such products would not meet the requirement of providing a nutritionally complete pet food product that is free from animal derived products, and that meets typical palatability requirements for commercial pet foods.

Therefore, it is an object of the present invention to provide a nutritionally complete pet food product that does not contain animal derived products, at least to the extent that it would meet the requirements of being marketed as an essentially ‘vegetarian’ pet food, but which meets typical palatability requirements for commercial pet foods.

### SUMMARY OF THE INVENTION

According to one aspect of the invention, there is provided a palatable, nutritionally complete vegetarian food for pet mammals, including a nutritionally complete, preferably low moisture, vegetarian kibble which incorporates a non-meat based flavour-enhancing additive. The additive includes a synergistic amount of hydrolyzed vegetable protein and xylose. The combination of these two ingredients provides an especially flavoursome character to the pet food. Typically, the mass ratio of hydrolyzed vegetable protein to xylose, at which this synergistic effect is observed, is between 15:1 and 40:1 on a dry mass basis. The hydrolyzed vegetable protein is available from commercial suppliers. It is typically available as a liquid dispersion, having a solids content of about 15%. Alternatively, it is available as a powder with an approximate moisture content of 10%. It will be apparent to those skilled in the art that if the powdered version is used, commensurate adjustments will need to be made to the level of moisture in the formulation of e.g. the spray to provide the preferred range of hydrolyzed vegetable protein solids in the additive.

Advantageously, the additive also includes one or more materials selected from a group comprising glucose, garlic powder and nature identical, non meat based chicken flavouring. Preferably, the additive is made up of the above ingredients in the following approximate mass proportions: hydrolyzed vegetable protein solids at between 1.5% and 4.0%; xylose at between 0.05% and 0.5%; chicken flavour at between 1.0% and 5.0%; glucose at between 5% and 15%; garlic powder at between 0.2% and 1.0%. The remainder of the additive may be made up of any suitable, relatively flavour-neutral dispersant, for example water.

Preferably, the additive is diluted in water to form a sprayable solution, and is sprayed on to the nutritionally complete, low moisture vegetarian kibble. This method of addition ensures that the flavour ingredients are not destroyed during extrusion and drying of the kibble. The spray should advantageously be added to the kibbles at a rate that provides an addition rate of the additive solids to the kibble of between about 6 kg to 12 kg of additive per 1000 kg of kibble, and most preferably between 8 kg to 10 kg of additive per 1000 kg of kibble.

An advantageous stage during the manufacture of the pet food is the heating of the diluted additive to between 80° C. to 100° C. for between 10 to 15 minutes prior to being sprayed on to the kibble. The heating promotes the development of further advantageous flavours.

In another aspect, the invention provides a flavour enhancing additive for nutritionally complete vegetarian pet mammal foods. The additive includes a synergistic amount of hydrolyzed vegetable protein and xylose, as described above, and preferably includes other optional flavour enhancing ingredients as described above.

In another aspect, the invention provides a method of enhancing the flavour of nutritionally complete vegetarian pet mammals foods. The method includes the steps of producing a low moisture, vegetarian pet food kibble, and adding to the kibble a flavour enhancing additive. The additive includes a synergistic amount of hydrolyzed vegetable protein and xylose, and preferably includes other optional flavour enhancing ingredients as described above.

In all of the above-described embodiments, it is preferred that the pet food is presented as a ready-to-eat combination of kibble and additive, but other formats are possible within the scope of the invention.

The nature of the invention will be further explained using a specific, non-limiting example of the manufacture and performance of a palatable, nutritionally complete vegetarian food for pet mammals.

### EXAMPLE

### Vegetarian Dry Dog Food

Nutritionally complete vegetarian dry dog food kibbles may be prepared by a number of ingredient-mixing and extrusion techniques that will be familiar to those skilled in the art. Such techniques are adequately outlined, for example, in U.S. Pat. No. 6,197,361.

The overall composition of the food kibbles prepared is given in Table 1. This precise composition is given only as an example. The invention is suitable for use in conjunction with a wide variety of different dry packeted pet food kibbles.

TABLE 1

| | Approximate % |
|---|---|
| Component | by weight |
| Broken rice | 38 |
| Whole Corn | 35 |
| Legume Protein | 10 |
| Safflower seeds | 5.0 |
| Vitamin & Mineral Blend | 6.0 |
| Soya meal | 4.7 |
| Sodium Caseinate | 1.3 |

A spray mixture, representing the flavour-enhancing additive, was made up having the approximate composition given in Table 2.

TABLE 2

| | Approximate % |
|---|---|
| Component | by weight |
| Water | 71 |
| Glucose | 10 |
| Manufactured soy sauce (approx. 85% moisture) | 15 |
| Chicken flavour | 1.9 |
| Garlic powder | 0.5 |
| Xylose | 0.1 |
| Stabilisers | 1.5 |

Each of the ingredients of the spray mixture is readily available from commercial sources. The manufactured-soy sauce consists of approximately 15% hydrolysed vegetable protein by mass and approximately 85% moisture.

The chicken flavour used was a nature-identical, non-animal-derived flavouring, of the kind available from many commercial flavour houses. The spray mixture was heated to about 100° C. and held at that temperature for about 10 minutes, to promote further flavour and aroma development. The kibble was coated with vegetable oil at an application rate of 50 kg per 1000 kg of kibble. The spray was applied to the kibble at a rate of 65 kg spray per 1000 kg of kibble. The application of the spray and the oil to the kibble was achieved by passing the kibbles through a tumbling drum, where the oil and spray were sprayed on to the kibbles via spray nozzles.

In order to demonstrate that the pet food described above displayed the requisite palatability for commercial pet foods, the nutritionally complete dry dog food described above (Diet A) was fed to a panel of dogs under controlled conditions. Also fed as part of a three-way feeding protocol were a commercial non-vegetarian packeted dry dog food, of a formulation which had displayed target palatability characteristics for dry dog foods (Diet B) and the above-described vegetarian kibble of Table 1, but having only a coating of vegetable oil of 50 kg per 1000 kg of kibble, and not the aqueous spray, containing the flavour additive components, given in Table 2 above (Diet C).

The feeding protocol was as follows: a Relative Acceptance Test (RAT) was performed, based on a panel of 144 dogs, including small/toy dogs, medium dogs and large dogs. Each animal was fed a fixed amount of each diet, one diet being fed per day over the three-day test period. Small/toy dogs were fed 150 g per day, medium dogs 300 g/day and large dogs 450 g/day.

Three measures were used to determine the relative palatability of the three diets:
(a) Amount eaten (g): Mean of the amount of the product offered that was eaten in a single meal occasion;
(b) Refusals: The percentage of meals where none of the product that was offered was eaten; and
(c) Enjoyment: Mean score (on a scale of 1 to 100) of the owner's perception of the animal's enjoyment of the meal, where a higher score means the animal appeared to enjoy the meal more.

The results of the feeding test are given in Table 3. The p-values given are based on a 95% confidence level.

TABLE 3

| Attribute | Diet A | Diet B | Diet C | p-value |
|---|---|---|---|---|
| Amount Eaten (g) | 186a | 188a | 171b | 0.004 |
| Refusals (%) | 10a | 9a | 14a | 0.142 |
| Enjoyment (scale 1-100) | 62ab | 66a | 59b | 0.003 |

The results underwent statistical analysis via an ANOVA model with post hoc comparison. The results from the above table indicate that Diet A achieved results in all categories that were not significantly different from the meat-based product (Diet B), and which were a significant improvement over the vegetarian kibble that did not have the flavour enhancing additive (Diet C), in the Amount Eaten category.

1. A palatable, nutritionally complete vegetarian food for pet mammals, including a nutritionally complete, preferably low-moisture, vegetarian kibble which incorporates a non-meat based flavour-enhancing additive, said additive including hydrolyzed vegetable protein and xylose, wherein the ratio of hydrolyzed vegetable protein to xylose is between 15:1 and 40:1 on a dry mass basis.

2. The pet food of claim 1, wherein the flavour-enhancing additive additionally includes one or more materials selected from a group consisting of glucose, garlic powder and nature-identical non-meat-based chicken flavouring.

3. The pet food of claim 2, wherein the flavour-enhancing additive includes the following materials in the following approximate mass proportions: hydrolyzed vegetable protein solids at between 1.5% and 4.0%; xylose at between 0.05% and 0.5%; nature-identical non-meat based chicken flavouring at between 1.0% and 5.0%; glucose at between 5% and 15%; garlic powder at between 0.2% and 1.0%.

4. The pet food of claim 1, wherein the flavour-enhancing additive is diluted in water to form a sprayable solution, and is incorporated in said kibble via spraying.

5. The pet food of claim 4, wherein said spray is added to the kibbles at a mass rate that provides an addition rate of the additive solids to the kibble of between about 6 kg to about 12 kg of additive per 1000 kg of kibble on a dry mass basis.

6. The pet food of claim 5, wherein said spray is added to the kibbles at a mass rate that provides an addition rate of the additive solids to the kibble of between about 8 kg to about 10 kg of additive per 1000 kg of kibble on a dry mass basis.

7. The pet food of claim 4, wherein the diluted additive is heated to between about 80° C. to about 100° C. for between about 10 to about 15 minutes prior to being sprayed on to the kibble.

8. A flavour-enhancing additive for nutritionally complete vegetarian pet mammal foods, said additive including hydrolyzed vegetable protein and xylose, wherein the ratio of hydrolyzed vegetable protein to xylose is between 15:1 and 40:1 on a dry mass basis.

9. The additive of claim 8, wherein the additive additionally including one or more materials selected from a group consisting of glucose, garlic powder and nature-identical non-meat-based chicken flavouring.

10. The additive of claim 9, wherein the additive includes the following materials in the following approximate mass proportions: hydrolyzed vegetable protein solids at between 1.5% and 4.0%; xylose at between 0.05% and 0.5%; nature-identical non-meat-based chicken flavouring at between 1.0% and 5.0%; glucose at between 5% and 15%; garlic powder at between 0.2% and 1.0%.

11. The additive of claim 8, wherein the flavour-enhancing additive is diluted in water to form a sprayable solution.

12. The additive of claim 11, wherein said solution is heated to between about 80° C. to about 100° C. for between about 10 to about 15 minutes.

13. A method of enhancing the flavour of nutritionally complete vegetarian pet mammals foods, said method including the steps of: producing a low moisture, vegetarian pet food kibble; and adding to the kibble a flavour-enhancing additive according to claim 8.

14. The method of claim 13, wherein the additive is added to the kibbles at a mass rate that provides an addition rate of the additive solids to the kibble of between about 6 kg to about 12 kg of additive per 1000 kg of kibble on a dry mass basis.

15. The method of claim 14, wherein the additive is added to the kibbles at a mass rate that provides an addition rate of the additive solids to the kibble of between about 8 kg to about 10 kg of additive per 1000 kg of kibble on a dry mass basis.

16. The method of claim 13, wherein the additive is incorporated in said kibble via spraying.
